(19) United States
(12) Patent Application Publication
(10) Pub. No.: US 2025/0037911 A1
(43) Pub. Date: Jan. 30, 2025

(54) SOFT MAGNETIC IRON ALLOY PLATE, IRON CORE USING THE SOFT MAGNETIC IRON ALLOY PLATE, AND ROTATING ELECTRIC MACHINE

(71) Applicant: Hitachi, Ltd., Tokyo (JP)

(72) Inventors: Tomohiro TABATA, Tokyo (JP); Matahiro KOMURO, Tokyo (JP); Yusuke ASARI, Tokyo (JP); Shohei TERADA, Tokyo (JP)

(21) Appl. No.: 18/717,102

(22) PCT Filed: Nov. 18, 2022
(86) PCT No.: PCT/JP2022/042836

§ 371 Date: Jun. 6, 2024

(30) Foreign Application Priority Data
Jan. 6, 2022 (JP) 2022-000898

(51) Int. Cl. H01F 1/147; C22C 38/00; C22C 38/24; C22C 38/30; H02K 1/02

(52) U.S. Cl. CPC H01F 1/147; C22C 38/001; C22C 38/24; C22C 38/30; H02K 1/02; C22C 2202/02

(57) ABSTRACT

Provided are a soft magnetic iron alloy plate that can suppress an excessive increase in Pi while exhibiting Bs higher than that of an electromagnetic pure iron plate and reduce the cost as compared with permendur, an iron core using the soft magnetic iron alloy plate, and a rotating electric machine. The soft magnetic iron alloy plate according to the present invention includes a chemical composition containing Co by 1 to 30 atom %, N by 0.2 to 10 atom %, an M component that can form an MN-type nitride by 0.5 to 5 atom %, with the balance being Fe and impurities, and when a cross section of the soft magnetic iron alloy plate is observed, nitride particles of the M component are deposited with an average particle size of 0.5 μm or less and a number density of 50 particles/100 μm² or less.

### TECHNICAL FIELD

The present invention relates to a technique of a soft magnetic material, and particularly relates to a soft magnetic iron alloy plate having a saturation magnetic flux density higher than that of an electromagnetic pure iron plate, an iron core using the soft magnetic iron alloy plate, and a rotating electric machine.

### BACKGROUND ART

As an iron core of a rotating electric machine or a transformer, a laminated iron core in which a plurality of soft magnetic materials such as electromagnetic pure iron plates or electromagnetic steel sheets (e.g., thickness of 0.01 to 1 mm) are laminated and formed is widely used. Regarding an iron core, it is important to have high conversion efficiency between electric energy and magnetic energy, and high magnetic flux density and low iron loss are important.

On the other hand, in a mechanical device using an iron core, cost reduction of a soft magnetic material is naturally one of important problems, and technology development for stably manufacturing a soft magnetic material at low cost while satisfying required characteristics has been actively conducted heretofore.

For example, PTL 1 (JP 2005-264315 A) discloses an electromagnetic steel sheet containing, by mass %, ≤0.0400% C, 0.2 to 4.0% Si, 0.05 to 5.0% Mn, ≤0.30% P, ≤0.020% S, ≤8.0% Al, ≤0.0400% N, the balance being Fe and inevitable impurities, the electromagnetic steel sheet mainly including a ferrite phase in a range in which a structure satisfies a ferrite phase: 50% or more and a martensite phase: 50% or less in terms of volume ratio, and including an intermetallic compound having a diameter of 0.050 pm or less inside a steel material. The electromagnetic steel sheet may contain 70 mass % or more of Fe and one or two or more kinds of Ni, Mo, Ti, Nb, Co, and W at ≤10.0 mass % relating to each element, may contain one or two or more kinds of Zr, Cr, B, Cu, Zn, Mg, and Sn at ≤10.0 mass % relating to each element, or may contain one or two or more kinds of Ag, Pt, Ga, Ge, In, V, Pd, Ir, Rh, Cd, and Ta at ≤5.0 mass % relating to each element.

According to PTL 1, it is possible to stably manufacture a high-strength non-oriented electromagnetic steel sheet having a high tensile strength of 60 kg/mm² or more at the time of use, deformation resistance, fatigue resistance, wear resistance, and the like, and also having excellent magnetic properties equivalent to those of a normal soft electromagnetic steel sheet.

PTL 2 (WO 2007/069776 A1) discloses a high-strength non-oriented electromagnetic steel sheet. The steel sheet comprises a component composition containing, by mass %, C: 0.010% or less, N: 0.010% or less and the content of C and N being suppressed to “C+N≤0.010%”, also containing Si: 1.5 to 5.0%, Mn: 3.0% or less, Al: 3.0% or less, P: 0.2% or less, S: 0.01% or less, and one or both of Ti and V: 0.01% to 0.8% in total and in a range that satisfies “(Ti+V)/(C+N)≥16”, with the balance being Fe and an inevitable impurity, and has a content of a non-recrystallized recovery structure of 50% or more. The high-strength non-oriented electromagnetic steel sheet may further contain at least one kind selected from the group consisting of, by mass %, Ni: 0.1 to 5.0%, Sb: 0.002 to 0.10%, Sn: 0.002 to 0.10%, B: 0.001 to 0.010%, Ca: 0.001 to 0.01%, Rem: 0.001 to 0.01%, and Co: 0.2 to 5.0%.

According to PTL 2, it is possible to provide a non-oriented electromagnetic steel sheet having high strength and excellent plate shape and magnetic properties, and a manufacturing method for the same, without substantially adding restrictions on steel sheet manufacturing and new steps to normal manufacturing of the non-oriented electromagnetic steel sheet.

PTL 3 (JP 2020-132894 A) discloses a plate-like or foil-like soft magnetic material having high saturation magnetic flux density, which contains iron, carbon and nitrogen and comprises martensite containing carbon and nitrogen and γ-Fe, wherein a phase containing nitrogen is formed in γ-Fe.

According to PTL 3, it is possible to manufacture, at low cost, a soft magnetic material having a saturation magnetic flux density exceeding that of pure iron and having thermal stability, enhance characteristics of a magnetic circuit of an electric motor or the like using the soft magnetic material, and achieve downsizing, high torque, and the like of the electric motor or the like.

### CITATION LIST

### Patent Literatures

PTL 1: JP 2005-264315 A
PTL 2: WO 2007/69776 Al
PTL 3: JP 2020-132894 A

### SUMMARY OF INVENTION

### Technical Problem

In a rotating electric machine, it is important to increase saturation magnetic flux density Bs of a soft magnetic material for high output and high torque, and it is important to suppress loss (iron loss Pi) of the soft magnetic material for high efficiency. Pi is the sum of hysteresis loss and eddy current loss, and a coercive force He is desirably small for reduction of the hysteresis loss, and high electrical resistance and thinning are effective for reduction of the eddy current loss.

The magnetic property of a commercially available electromagnetic pure iron plate is said to be Bs≈2.1 T. An iron core using an electromagnetic pure iron plate has advantages of high Bs and low material cost, but has a disadvantage that Pi tends to be large because He is relatively high. The electromagnetic steel sheets of PTLs 1 and 2 have an advantage of high mechanical strength and small Pi, but has a disadvantage that Bs of the entire iron core does not exceed that of the iron core of electromagnetic pure iron because Bs is smaller than that of the electromagnetic pure iron plate. The soft magnetic material of PTL 3 has an advantage of having Bs higher than that of the electromagnetic pure iron plate, but is considered to have a disadvantage that He is higher than that of the electromagnetic pure iron plate.

As an iron-based material having Bs higher than that of the electromagnetic pure iron plate, an Fe—Co-based material and an Fe—N-based martensite material are known.

In Fe—Co-based materials, permendur (49Fe-49Co-2V mass %=50Fe-48Co-2V atom %) is the material that exhibits the highest Bs (about 2.4 T) among the soft magnetic materials currently commercialized. However, the material cost of Co fluctuates depending on the market condition, but is 100 to 200 times higher than the material cost of Fe, and thus permendur has a disadvantage that the material cost is high. Permendur has a slight drawback in workability, and also has a disadvantage that the processing cost tends to be high. Reduction in Co content can reduce the material cost accordingly and improves the workability, but there is a disadvantage that Bs, which is the largest feature, is also reduced.

On the other hand, Fe—N-based martensite materials (e.g., FesN phase (α′ phase) and Fe₁₆N₂ phase (α″ phase)) are attractive materials that have material cost overwhelmingly lower than that of permendur and exhibit high Bs comparable to permendur. However, there is a disadvantage that He and Pi are likely to increase due to an increase in distortion of a crystal lattice due to N atom penetration and a distortion difference between crystal lattices due to a local concentration difference of N atoms.

In recent years, there has been a strong demand for high torque and high output designs in a rotating electric machine and a transformer, and Bs improvement of the soft magnetic material has been strongly demanded. In other words, Bs improvement of the soft magnetic material is more prioritized, and if the improvement degree of Bs is large, a Pi increase to some extent tends to be permitted. For example, if Bs of more than 2.20 T can be achieved, Pi=60 W/kg is permissible in designing a rotating electric machine.

Therefore, an object of the present invention is to provide a soft magnetic iron alloy plate that can suppress an excessive increase in Pi while exhibiting Bs higher than that of an electromagnetic pure iron plate and reduce the cost as compared with permendur, an iron core using the soft magnetic iron alloy plate, and a rotating electric machine.

### Solution to Problem

(I) One aspect of the present invention is a soft magnetic iron alloy plate, including:
a chemical composition containing cobalt (Co) by 1 atom % or more and 30 atom % or less, nitrogen (N) by 0.2 atom % or more and 10 atom % or less, and an M component that can form an MN-type nitride by 0.5 atom % or more and 5 atom % or less, with the balance being iron (Fe) and impurities,
wherein when a cross section of the soft magnetic iron alloy plate is observed, nitride particles of the M component are deposited with an average particle size of 0.5 pm or less and a number density of 50 particles/100 μm² or less.

Note that in the present invention, the average particle size of nitride particles is an average of diameters of equivalent area circles of the nitride particles observed by microstructure observation (e.g., scanning electron microscope observation). The number density is the number of deposited nitride particles per predetermined area observed by microstructure observation.

In the present invention, the following improvements and changes can be made to the soft magnetic iron alloy plate (I) described above.
(i) The M component is one kind or more of V, Cr, Ti, Al, Nb, and Mo.
(ii) An occupancy of nitride particles of the M component is 10 area % or less when a cross section of the soft magnetic iron alloy plate is observed.
(iii) Saturation magnetic flux density is more than 2.20 T, and iron loss is 60 W/kg or less.
(iv) Vickers hardness is 200 or more.

(II) Another aspect of the present invention is an iron core including a laminate of a soft magnetic iron alloy plate, in which the soft magnetic iron alloy plate is the soft magnetic iron alloy plate according to the present invention described above.

(III) Still another aspect of the present invention provides a rotating electric machine including an iron core, in which the iron core is the iron core according to the present invention described above.

### Advantageous Effects of Invention

According to the present invention, it is possible to provide a soft magnetic iron alloy plate that can suppress an excessive increase in Pi while exhibiting Bs higher than that of an electromagnetic pure iron plate and reduce the cost as compared with permendur, an iron core using the soft magnetic iron alloy plate, and a rotating electric machine.

### BRIEF DESCRIPTION OF DRAWINGS

FIG. 1 is a process chart showing an example of a method for manufacturing a soft magnetic iron alloy plate according to the present invention.

FIG. 2 is a scanning electron microscope (SEM) observation image of a cross section of an iron alloy plate 2.

FIG. 3 is an SEM observation image of a cross section of an iron alloy plate 3.

FIG. 4A is a schematic perspective view illustrating an example of a stator of a rotating electric machine.

FIG. 4B is an enlarged transverse cross-sectional schematic view of a slot region of the stator.

### DESCRIPTION OF EMBODIMENTS

As a basic idea of the present invention, it has been considered that the Co content is reduced as compared with permendur to reduce the material cost, and a decrease in Bs due to the reduction in the Co content is compensated by generation of an Fe—N-based martensite phase. However, it has been considered that in an Fe—Co-based material, N atoms are difficult to penetrate and diffuse, and it is difficult to generate the Fe—N-based martensite phase.

When an element that promotes penetration and diffusion of N atoms is simply added to the Fe—Co-based material in order to generate the Fe—N-based martensite phase, nonmagnetic nitride particles are easily generated, and the generated nitride particles act as a pinning point that hinders domain wall motion at the time of magnetization reversal. A problem that the generation of nonmagnetic particles leads to a decrease in Bs and the pinning point of the domain wall leads to an increase in Pi occurs.

As described above, an object of the soft magnetic iron alloy plate of the present invention is to exhibit Bs superior to that of an electromagnetic pure iron plate. From many experiments by the present inventors, it has been found that when Bs is improved by 0.03 T or more as compared with the soft magnetic material of a comparison target, it is deemed to be a clear characteristic improvement or significant difference. For this reason, the soft magnetic iron alloy plate of the present invention needs to exhibit Bs of at least 2.17 T or more. From the viewpoint of recent demand for high torque and high output in a rotating electric machine, Bs of 2.21 T or more is more desirable, and Bs of 2.24 T or more is still more desirable.

Therefore, the present inventors have intensively studied a method for penetrating and diffusing nitrogen atoms into an Fe—Co-based alloy plate and effectively generating an Fe—N-based martensite phase. As a result, the present inventors have found that it is possible to generate an Fe—N-based martensite phase while suppressing generation of nitride particles by adding an element that promotes penetration and diffusion of N atoms (M component that can form an MN-type nitride) and performing penetration and diffusion of N atoms in a temperature region where diffusion and rearrangement of the M component are difficult (temperature region where the diffusion coefficient is sufficiently small). The present invention has been completed based on this finding.

Hereinafter, an embodiment according to the present invention will be specifically described along a manufacturing procedure with reference to the drawings. However, the present invention is not limited to the embodiment described here, and can be appropriately combined with a known technique or improved based on a known technique without departing from the technical idea of the invention.

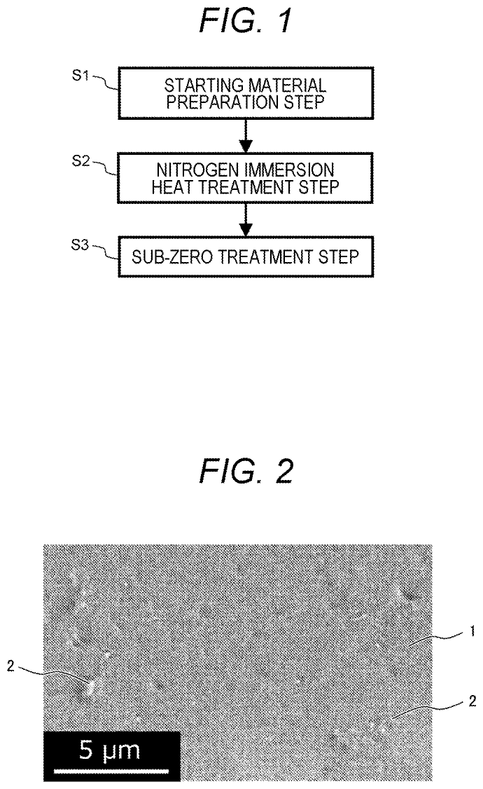

FIG. 1 is a process chart showing an example of a method for manufacturing a soft magnetic iron alloy plate according to the present invention. As shown in FIG. 1, the manufacturing method of the soft magnetic iron alloy plate of the present invention schematically includes a starting material preparation step S1, a nitrogen immersion heat treatment step S2, and a sub-zero treatment step S3. Hereinafter, each of the steps will be described more specifically.

In the starting material preparation step S1, a plate material (thickness 0.01 mm or more and 1 mm or less) containing Fe as a main component (a component having the maximum content), Co by 1 atom % or more and 30 atom % or less, and an M component that can form an MN-type nitride by 0.5 atom % or more and 5 atom % or less is prepared as a starting material.

By setting the Co content to 30 atom % or less, it is possible to greatly reduce the material cost as compared with that of permendur. From the viewpoint of securing excellent Bs, the lower limit of the Co content is more preferably 5 atom % or more, still more preferably 10 atom % or more. From the viewpoint of material cost reduction, the upper limit of the Co content is more preferably 25 atom % or less, still more preferably 20 atom % or less.

As the M component that can form the MN-type nitride, one kind or more of V, Cr, Ti, Al, Nb, and Mo can be preferably used, and the M component is preferably contained by 0.5 atom % or more and 5 atom % or less. From the viewpoint of promoting penetration and diffusion of N atoms, the lower limit of the M component content is more preferably 1 atom % or more, still more preferably 1.5 atom % or more. From the viewpoint of suppressing generation of nitride particles, the upper limit of the M component content is more preferably 4 atom % or less, still more preferably 3.5 atom % or less.

Note that the MN-type nitride means a nitride in which atoms of M and nitrogen atoms are combined at a ratio of “1:1”. Impurities (impurities that can be included in the starting material, for example, hydrogen (H), boron (B), carbon (C), silicon (S1), phosphorus (P), sulfur (S), manganese (Mn), nickel (Ni), copper (Cu), and the like) are permitted in a range where they do not have a particular adverse effect on Bs of the soft magnetic iron alloy plate (e.g., the total concentration of within 2 atom %).

Next, in the nitrogen immersion heat treatment step S2, nitrogen immersion heat treatment is performed to penetrate and diffuse N atoms into a plate material of the prepared starting material. Nitrogen immersion is performed up to a desired N content, followed by rapid cooling to generate a martensite phase. The manufacturing method of a soft magnetic iron alloy plate according to the present invention has the largest feature in this nitrogen immersion heat treatment step S2.

The N content (average content of the entire iron alloy plate) in step S2 is preferably 0.2 atom % or more and 10 atom % or less. When the N content is 0.2 atom % or more, a significant amount of the Fe—N-based martensite phase (FesN phase (α′ phase) and/or Fe₁₆N₂ phase (α″ phase)) is generated, and contributes to improvement of Bs. When the N content is 10 atom % or less, generation of an undesired iron nitride phase (e.g., Fe₄N phase (γ′ phase) or Fe₃N phase (ε phase)) can be suppressed. The lower limit of the N content is more preferably 0.3 atom % or more, still more preferably 0.4 atom % or more. The upper limit of the N content is more preferably 5 atom % or less, still more preferably 3 atom % or less.

The nitrogen immersion heat treatment is preferably performed under a predetermined NH₃ (ammonia) gas atmosphere in a temperature region in which decomposition reaction of NH₃ occurs and N atoms can penetrate the inside of the starting material, the temperature region in which diffusion/rearrangement of the M component is difficult (a temperature region in which a diffusion coefficient is sufficiently small). Specifically, 450° C. or more and 700° C. or less is preferable, 480° C. or more and 650° C. or less is more preferable, and 500° C. or more and 600° C. or less is still more preferable.

As the NH₃ gas atmosphere, in addition to the NH₃ gas alone, a mixed gas of the NH₃ gas and a N₂ gas, a mixed gas of an NH₃ gas and an argon (Ar) gas, or a mixed gas of the NH₃ gas and a H₂ gas can be suitably used. Introduction of the NH₃ gas is preferably performed after the temperature reaches 450° C. or more. This is because when the NH₃ gas is actively introduced from a low temperature region of less than 450° C., an undesired iron nitride phase (γ′ phase or E phase) is more likely to be generated than an Fe—N-based martensite phase (α′ phase and/or a″ phase) having a desirable tetragonal structure.

Control of the N content in the iron alloy plate can be performed by control of the heat treatment temperature, the NH₃ gas partial pressure, and/or the NH₃ gas supply time. The distribution control of the N content in a thickness direction (plate thickness direction) of the iron alloy plate can be performed by alternately switching between an atmosphere containing the NH₃ gas and an atmosphere not containing the NH₃ gas.

Most of an austenite phase (γ phase) can be transformed into a martensite structure by rapid cooling in the nitrogen immersion heat treatment step S2, but a part of they phase may remain (residual γ phase). Since they phase is nonmagnetic, the volume ratio of the residual γ phase is preferably 5% or less from the viewpoint of magnetic property.

Therefore, following the nitrogen immersion heat treatment step S2, it is preferable to perform the sub-zero treatment step S3 in order to transform the residual γ phase into the martensite structure. The sub-zero treatment is a treatment for cooling to 0° C. or less, and normal sub-zero treatment using dry ice or a super-sub-zero treatment using liquid nitrogen can be preferably used.

Although not an essential step, for the purpose of imparting toughness to the soft magnetic iron alloy plate, a tempering step S4 at 100° C. or more and 210° C. or less may be further performed after the sub-zero treatment step S3 (not shown in FIG. 1).

As described above, by penetrating and diffusing N atoms of 0.2 atom % or more and 10 atom % or less in a temperature region (temperature region where the diffusion coefficient is sufficiently small) in which diffusion and rearrangement of the M component is difficult, with respect to a plate material containing Fe as a main component, Co by 1 to 30 atom %, and the M component that can form an MN-type nitride by 0.5 to 5 atom %, and then performing rapid cooling, it is possible to generate an Fe—N-based martensite phase while suppressing generation of nitride particles.

In other words, by containing the M component, it is possible to penetrate and diffuse the N atoms of a desired content over the entire plate material, and by suppressing the penetration and diffusion temperature of the N atoms to be low, it is possible to suppress deposition of the nitride particles of the M component to an average particle size of 0.5 μm or less and a number density of 50 particles/100 μm² or less, and it is possible to suppress the occupancy of the nitride particles to 10 area % or less. The average particle size, the number density, and the occupancy of the nitride particles are more preferably 0.4 μm or less, 40 particles/100 μm² or less, and 5 area % or less, and still more preferably 0.3 μm or less, 30 particles/100 μm² or less, and 2 area % or less, respectively.

As a result, the soft magnetic iron alloy plate of the present invention can suppress an increase in Pi due to generation of nitride particles while achieving Bs higher than that of the electromagnetic pure iron plate. Specifically, Bs is more than 2.20 T, and Pi can be suppressed to 60 W/kg or less.

### [Iron Core and Rotating Electric Machine]

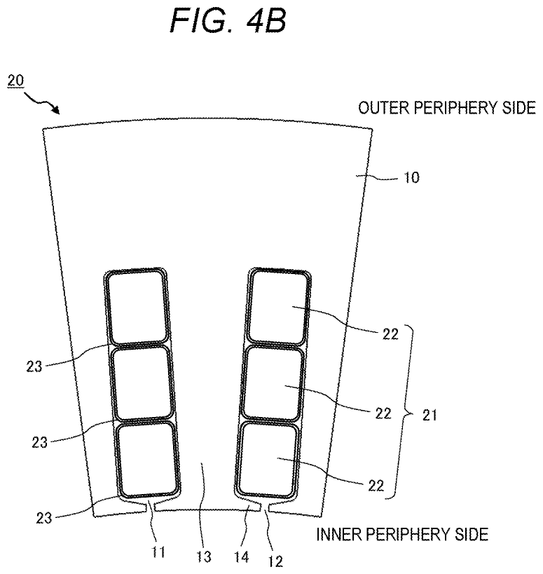

FIG. 4A is a schematic perspective view illustrating an example of a stator of a rotating electric machine, and FIG. 4B is an enlarged transverse cross-sectional schematic view of a slot region of the stator. Note that the transverse cross section means a cross section orthogonal to a rotation axis direction (a cross section whose normal line is parallel to the axial direction). In the rotating electric machine, a rotor (not illustrated) is disposed radially inside the stator in FIGS. 4A and 4B.

As illustrated in FIGS. 4A and 4B, a stator 20 is formed by winding a stator coil 21 around a plurality of stator slots 11 formed on the inner periphery side of an iron core 10. The stator slots 11 are spaces formed to be arrayed at a predetermined circumferential pitch in the circumferential direction of the iron core 10 and formed to penetrate in the axial direction, and a slit 12 extending in the axial direction is opened in the innermost peripheral part. A region partitioned by the stator slots 11 adjacent to each other is called teeth 13 of the iron core 10, and a part defining the slit 12 in an inner periphery side tip end region of the teeth 13 is called a teeth claw portion 14.

The stator coil 21 normally includes a plurality of segment conductors 22. For example, in FIGS. 4A and 4B, the stator coil 21 includes three segment conductors 22 corresponding to a U phase, a V phase, and a W phase of three-phase alternating current. From the viewpoint of preventing partial discharge between the segment conductor 22 and the iron core 10 and partial discharge between each phase (U-phase, V-phase, and W-phase), the outer periphery of each of the segment conductors 22 is normally covered with an electric insulating material 23 (e.g., insulating paper and enamel coating).

The rotating electric machine according to the present invention is a rotating electric machine using the iron core 10 of the present invention. Since the iron core 10 of the present invention has Bs higher than that of an iron core made of a conventional electromagnetic pure iron plate or an electromagnetic steel sheet, it leads to high torque and high output of the rotating electric machine. Since the iron core 10 of the present invention can be made lower in cost than an iron core made of a permendur plate, it is possible to suppress an excessive cost rise of the rotating electric machine.

### EXAMPLES

Hereinafter, the present invention will be described more specifically by various experiments. However, the present invention is not limited to the configurations and structures described in these experiments.

### [Experiment 1]

(Preparation of starting material 1, reference sample 1, and reference sample 2)

Commercially available pure metal raw materials (each of Fe, Co, V, and Cr has purity=99.9%) were mixed, and an alloy ingot was produced by an arc melting method (automatic arc melting furnace manufactured by Diavac Limited., under reduced pressure Ar atmosphere) on water-cooled copper hearth. At this time, for alloy ingot homogenization, remelting was repeated six times while reversing the sample. The obtained alloy ingots were subjected to press working and rolling working to prepare an Fe-18.5 atom % Co-2.2 atom % V-1.1 atom % Cr alloy plate (thickness=0.1 mm) as a starting material 1.

The starting material 1 was subjected to processing strain removal annealing at 500° C. in an Ar gas atmosphere (0.8×10⁵ Pa) to prepare a reference sample 1. A commercially available electromagnetic steel sheet (thickness=0.35 mm, 35H300 manufactured by Nippon Steel Corporation) was separately prepared a reference sample 2.

### [Experiment 2]

(Production of iron alloy plate 1)

As the nitrogen immersion heat treatment step, the starting material 1 prepared in Experiment 1 was heated to 500° C. in N₂ gas atmosphere (0.8×10⁵ Pa) and held for 30 minutes, and then the NH₃ gas atmosphere (0.8×10⁵ Pa, 1 minute) and the N₂ gas atmosphere (0.8×10⁵ Pa, 20 minutes) were alternately repeated to penetrate and diffuse N atoms so as to have an N content of about 0.4 atom %, and water quenching (20° C.) was performed. Thereafter, the super-sub-zero treatment in which the sample material was immersed in liquid nitrogen was performed within 5 minutes to produce an iron alloy plate 1.

### [Experiment 3]

### (Production of Iron Alloy Plate 2)

As the nitrogen immersion heat treatment step, the starting material 1 prepared in Experiment 1 was heated to 600° C. in N₂ gas atmosphere (0.8×10⁵ Pa) and held for 30 minutes, and then the NH₃ gas atmosphere (0.8×10⁵ Pa, 10 minutes) and the N₂ gas atmosphere (0.8×10⁵ Pa, 20 minutes) were alternately repeated to penetrate and diffuse N atoms so as to have an N content of about 1.1 atom %, and water quenching (20° C.) was performed. Thereafter, the super-sub-zero treatment in which the sample material was immersed in liquid nitrogen was performed within 5 minutes to produce an iron alloy plate 2.

### [Experiment 4]

(Production of iron alloy plate 3)

As the nitrogen immersion heat treatment step, the starting material 1 prepared in Experiment 1 was heated to 900° C. in N₂ gas atmosphere (0.8×10⁵ Pa) and held for 30 minutes, and then the NH₃ gas atmosphere (0.8×10⁵ Pa, 1 minute) and the N₂ gas atmosphere (0.8×10⁵ Pa, 20 minutes) were alternately repeated to penetrate and diffuse N atoms so as to have an N content of about 1.5 atom %, and water quenching (20° C.) was performed. Thereafter, the super-sub-zero treatment in which the sample material was immersed in liquid nitrogen was performed within 5 minutes to produce an iron alloy plate 3.

### [Experiment 5]

### (Production of Iron Alloy Plate 4)

As the nitrogen immersion heat treatment step, the starting material 1 prepared in Experiment 1 was heated to 900° C. in N₂ gas atmosphere (0.8×10⁵ Pa) and held for 30 minutes, and then the NH₃ gas atmosphere (0.8×10⁵ Pa, 10 minutes) and the N₂ gas atmosphere (0.8×10⁵ Pa, 20 minutes) were alternately repeated to penetrate and diffuse N atoms so as to have an N content of about 3.4 atom %, and water quenching (20° C.) was performed. Thereafter, the super-sub-zero treatment in which the sample material was immersed in liquid nitrogen was performed within 5 minutes to produce an iron alloy plate 4.

As described above, the iron alloy plates 1 and 2 have the temperature of the nitrogen immersion heat treatment step kept relatively low and are samples of an iron alloy plate as an example of the present invention. The iron alloy plates 3 and 4 have a relatively high temperature in the nitrogen immersion heat treatment step and are samples of a comparative example of the present invention.

### [Experiment 6]

(Property examination and magnetic property examination of iron alloy plates 1 to 4, reference sample 1, and reference sample 2)

First, the surface of each sample was subjected to wide-angle X-ray diffraction measurement (WAXD) with Cu-Ku rays using an X-ray diffractometer (Rint-Ultima III manufactured by Rigaku Corporation) to identify a crystal phase.

As a result, in the reference sample 1 and the reference sample 2, a diffraction peak of only the α phase (ferrite phase) was confirmed. On the other hand, in the iron alloy plates 1 to 4, diffraction peaks of an α′ phase (Fe₈N phase), a VN phase (vanadium nitride phase), and a CrN phase (chromium nitride phase) were confirmed with the α phase being a main phase. In the iron alloy plate 4, a diffraction peak of the E phase (Fe₃N phase) was also confirmed.

From these results, it was confirmed that the α′ phase of the Fe—N-based martensite phase and the VN phase and the CrN phase of the MN-type nitride phase were generated by the nitrogen immersion heat treatment step and the sub-zero treatment step. The results are listed in Table 1 described below.

A test piece for microstructure observation was collected from each sample, and a test piece cross section was mirror-polished to perform picric acid aqueous solution etching. Microstructure observation was performed on the cross section using a scanning electron microscope (SEM, S4800 manufactured by Hitachi High-Tech Corporation). Image analysis was performed on the obtained SEM observation image, the number density was calculated from the number of deposited particles observed in a square having an area of 100 μm², and the occupancy (area %) of deposited particles in the square of 100 μm² was calculated. Furthermore, the average particle size of the deposited particles observed in the square of 100 μm² (the average of the diameters of the equivalent area circles of the deposited particles) was calculated. The results are also given in Table 1.

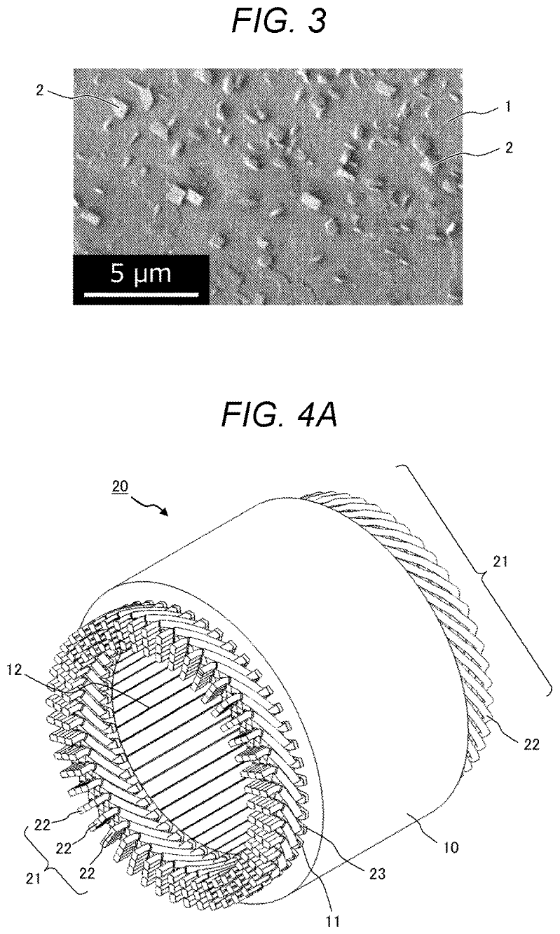

FIG. 2 is a cross-sectional SEM observation image of the iron alloy plate 2, and FIG. 3 is a cross-sectional SEM observation image of the iron alloy plate 3. As illustrated in FIG. 2 to 3, it can be seen that the deposited particles 2 are scattered in a matrix phase 1. When the iron alloy plate 2 and the iron alloy plate 3 are compared with each other, it is easily confirmed that the number density and the occupancy of the deposited particles 2 are greatly different. Putting together the results of WAXD, the deposited particle 2 is considered to be a particle of the VN phase and the CrN phase (i.e., MN-type nitride particle).

Quantitative analysis of the N concentration was performed on the test piece cross section for microstructure observation using an electronic probe microanalyzer (EPMA, JXA-8530F manufactured by JEOL Ltd). Specifically, spot measurement was performed at 200 points at equal intervals along the thickness direction (plate thickness direction) of the test piece cross section, and the average value thereof was taken as the N content. The average of the measurement values of only the matrix phase region (region that is not a deposited particle) among the spot measurement at 200 points was calculated as the matrix phase N concentration. The results are also given in Table 1.

Next, as a mechanical property, the Vickers hardness (Hv) was measured on a cross section of a test piece for microstructure observation using a micro Vickers hardness meter (AMT-X7AFS manufactured by Matsuzawa Co., Ltd) (Load: 100 gf, holding time: 15 seconds, average of 10 point measurement). The results are also given in Table 1.

The magnetic properties (Bs, Hc, and Pi) of each sample were examined. Magnetization (unit: emu) of the sample was measured under the conditions of a magnetic field of 1.6 MA/m and a temperature of 20° C. using a vibrating sample magnetometer (BHV-525H manufactured by Riken Denshi Co., Ltd), and the saturation magnetic flux density Bs (unit: T) and the coercive force He (unit: A/m) were obtained from the sample volume and the sample mass. The iron loss Pi_{-1.0/400} (unit: W/kg) of the sample was measured under the conditions of a magnetic flux density of 1.0 T and 400 Hz and a temperature of 20° C. by an H coil method (compliance JIS C 2556:2015) using a BH loop analyzer (IF-BH550 manufactured by IFG Corporation) and a vertical yoke single plate tester. The results are shown in Table 2.

TABLE 1
Property examination results of iron alloy plates 1 to 4, reference sample 1, and reference sample 2

| | | | | Deposited particle | | | |
|---|---|---|---|---|---|---|---|
| | | | | Average | Number | | Vickers |
| | | Matrix phase N | | particle size | density (/100 | Occupancy | hardness |
| | N content | concentration | Crystal phase | (μm) | μm²) | (area %) | (Hv) |
| Reference | 0.0 | — | α phase | — | — | — | 149 |
| sample 1 | | | | | | | |
| Reference | 0.0 | — | α phase | — | — | — | 200 |
| sample 2 | | | | | | | |
| Iron alloy plate | 0.4 | 0.4 | α phase | 0.19 | 5 | 0.14 | 200 |
| 1 | | | α′ phase | | | | |
| | | | VN phase | | | | |
| | | | CrN phase | | | | |
| Iron alloy plate | 1.1 | 1.1 | α phase | 0.25 | 6 | 0.29 | 656 |
| 2 | | | α′ phase | | | | |
| | | | VN phase | | | | |
| | | | CrN phase | | | | |
| Iron alloy plate | 1.5 | 0.4 | α phase | 0.58 | 67 | 18 | 300 |
| 3 | | | α′ phase | | | | |
| | | | VN phase | | | | |
| | | | CrN phase | | | | |
| Iron alloy plate | 3.4 | 0.8 | α phase | 0.70 | 114 | 44 | 392 |
| 4 | | | α′ phase | | | | |
| | | | ε phase | | | | |
| | | | VN phase | | | | |
| | | | CrN phase | | | | |

TABLE 2
Magnetic property examination results of iron alloy plates
1 to 4, reference sample 1, and reference sample 2

Magnetic property

| | Bs (T) | Hc (A/m) | Pi_{-1.0/400} (W/kg) |
|---|---|---|---|
| Reference sample 1 | 2.20 | 140 | 29 |
| Reference sample 2 | 2.00 | 55 | 20 |
| Iron alloy plate 1 | 2.27 | 200 | 39 |
| Iron alloy plate 2 | 2.30 | 298 | 53 |
| Iron alloy plate 3 | 2.26 | 1300 | 142 |
| Iron alloy plate 4 | 2.26 | 2880 | 346 |

The results in Table 1 indicate that the N content increases over the iron alloy plates 1 to 4, and an Fe—N-based martensite phase (α′ phase) and an MN-type nitride phase (VN phase and CrN phase) are generated. Considering the manufacturing process of the iron alloy plates 1 to 4 (nitrogen immersion heat treatment step in Experiments 2 to 5), it is confirmed that the N content increases when the heat treatment temperature is increased or the NH₃ gas supply time is lengthened.

Here, in the iron alloy plates 3 and 4 in which the temperature of the nitrogen immersion heat treatment step is relatively high, the deposition amount of the MN-type nitride particles is large, and the matrix phase N concentration is low compared with the N content of the entire iron alloy plate. On the other hand, in the iron alloy plates 1 and 2 in which the temperature of the nitrogen immersion heat treatment step is relatively low, the deposition amount of the MN-type nitride particles is small, and the N content of the entire iron alloy plate and the matrix phase N concentration are the same. These indicate that generation and deposition of the MN-type nitride particles can be suppressed by setting the temperature of the nitrogen immersion heat treatment step to be low (setting a temperature region in which diffusion and rearrangement of the M component are difficult).

It is confirmed that the Vickers hardness increases as the matrix phase N concentration increases (as the generation amount of the α′ phase increases as a result). Since the Vickers hardness has a positive correlation with the mechanical strength such as the tensile strength, it is expected that the mechanical strength is also increased when the matrix phase N concentration is increased to increase the α′ phase generation amount.

Based on the results in Tables 1 and 2, the reference sample 2, which is a commercially available electromagnetic steel sheet, exhibits sufficiently low He and Pi-1.0/400, but Bs does not reach Bs (about 2.1 T) of the electromagnetic pure iron plate. The reference sample 1 in which the N component has not penetrated and diffused and the α′ phase is not generated has Bs higher than that of the electromagnetic pure iron plate, but the Bs is greatly lowered from Bs (about 2.4 T) of permendur.

On the other hand, in the iron alloy plates 1 and 2 as examples of the present invention, the N component is penetrated and diffused to generate the α′ phase, whereby Bs is clearly improved as compared with the reference sample 1, and Pi_{-1.0/400} exhibits 60 W/kg or less.

On the other hand, in the iron alloy plates 3 and 4, which are the comparative examples, since the matrix phase N concentration is not so high (clearly lower than the N content), the generation amount of the α′ phase is also considered not large, and Bs is about the same as that of the iron alloy plate 1. Since a large amount of nitride particles are generated and deposited, He and Pi_{-1.0/400} are very high.

The above experiments have confirmed and demonstrated that it is possible to suppress an excessive increase in Pi while exhibiting excellent Bs by penetrating and diffusing N atoms in a temperature region (temperature region in which the diffusion coefficient is sufficiently small) in which diffusion and rearrangement of the M component is difficult for an Fe—Co-M-based alloy plate (M is an element that can form an MN-type nitride) to generate an α′ phase and/or an α″ phase and suppressing deposition of nitride particles of the M component to a predetermined level or less.

The above-described embodiment and experiments have been described in order to help understanding of the present invention, and the present invention is not limited only to the specific configurations described. For example, a part of the configuration of the embodiment can be replaced with the configuration of the common general technical knowledge of those skilled in the art, and the configuration of the common general technical knowledge of those skilled in the art can be added to the configuration of the embodiment. That is, in the present invention, a part of the configurations of the embodiment and experiments of the present description can be deleted, replaced with another configuration, or added with another configuration in a range without departing from the technical idea of the invention.

### REFERENCE SIGNS LIST

1 matrix phase
2 deposited particle
10 laminated iron core
11 stator slot
12 slit
13 teeth
14 teeth claw portion
20 stator
21 stator coil
22 segment conductor
23 electric insulating material

1. A soft magnetic iron alloy plate comprising a chemical composition containing Co by 1 atom % or more and 30 atom % or less, N by 0.2 atom % or more and 10 atom % or less, and an M component that can form an MN-type nitride by 0.5 atom % or more and 5 atom % or less, with the balance being Fe and impurities,
wherein when a cross section of the soft magnetic iron alloy plate is observed, nitride particles of the M component are deposited with an average particle size of 0.5 m or less and a number density of 50 particles/100 μm² or less.

2. The soft magnetic iron alloy plate according to claim 1, wherein the M component is one kind or more of V, Cr, Ti, Al, Nb, and Mo.

3. The soft magnetic iron alloy plate according to claim 1, wherein an occupancy of nitride particles of the M component is 10 area % or less when a cross section of the soft magnetic iron alloy plate is observed.

4. The soft magnetic iron alloy plate according to claim 1, wherein saturation magnetic flux density is more than 2.20 T and iron loss is 60 W/kg or less.

5. The soft magnetic iron alloy plate according to claim 1, wherein a Vickers hardness is 200 or more.

6. An iron core including a laminate of a soft magnetic iron alloy plate, wherein the soft magnetic iron alloy plate is the soft magnetic iron alloy plate according to claim 1.

7. A rotating electric machine including an iron core, wherein the iron core is the iron core according to claim 6.

8. The soft magnetic iron alloy plate according to claim 2, wherein an occupancy of nitride particles of the M component is 10 area % or less when a cross section of the soft magnetic iron alloy plate is observed.

9. The soft magnetic iron alloy plate according to claim 2, wherein saturation magnetic flux density is more than 2.20 T and iron loss is 60 W/kg or less.

10. The soft magnetic iron alloy plate according to claim 3, wherein saturation magnetic flux density is more than 2.20 T and iron loss is 60 W/kg or less.

11. The soft magnetic iron alloy plate according to claim 8, wherein saturation magnetic flux density is more than 2.20 T and iron loss is 60 W/kg or less.

12. The soft magnetic iron alloy plate according to claim 2, wherein a Vickers hardness is 200 or more.

13. The soft magnetic iron alloy plate according to claim 3, wherein a Vickers hardness is 200 or more.

14. The soft magnetic iron alloy plate according to claim 4, wherein a Vickers hardness is 200 or more.

15. The soft magnetic iron alloy plate according to claim 8, wherein a Vickers hardness is 200 or more.

16. The soft magnetic iron alloy plate according to claim 9, wherein a Vickers hardness is 200 or more.

17. The soft magnetic iron alloy plate according to claim 10, wherein a Vickers hardness is 200 or more.

18. The soft magnetic iron alloy plate according to claim 11, wherein a Vickers hardness is 200 or more.
